(19) United States
(12) Patent Application Publication
(10) Pub. No.: US 2026/0079467 A1
(43) Pub. Date: Mar. 19, 2026

(54) METHODS AND DEVICES FOR MACHINE TOOL ACCURACY COMPENSATION, STORAGE MEDIUM, AND ELECTRONIC DEVICES

(71) Applicant: CHENGDU AIRCRAFT INDUSTRIAL (GROUP) CO., LTD., Chengdu (CN)

(72) Inventors: Liangqiang DAI, Chengdu (CN); Dawei LIU, Chengdu (CN); Debiao ZENG, Chengdu (CN); Ying LI, Chengdu (CN); Xuezhen CHEN, Chengdu (CN); Yuanmeng XIA, Chengdu (CN); Chongkai PAN, Chengdu (CN); Qiang XU, Chengdu (CN); Ruihua GUO, Chengdu (CN); Guangliang DONG, Chengdu (CN); Qiangrong GAO, Chengdu (CN); Weiwei ZHANG, Chengdu (CN); Changyong ZHAO, Chengdu (CN); Chao ZHOU, Chengdu (CN); Jian GAN, Chengdu (CN); Fengfeng GAO, Chengdu (CN); Sang CHEN, Chengdu (CN); Bing LIU, Chengdu (CN); Xiang ZHOU, Chengdu (CN); Houchuan ZHOU, Chengdu (CN)

(73) Assignee: CHENGDU AIRCRAFT INDUSTRIAL (GROUP) CO., LTD., Chengdu (CN)

(21) Appl. No.: 19/399,566

(22) Filed: Nov. 24, 2025

Related U.S. Application Data
(63) Continuation of application No. PCT/CN2023/130928, filed on Nov. 10, 2023.

(30) Foreign Application Priority Data
Jun. 9, 2023 (CN) 202310681855.4

(51) Int. Cl. G05B 19/404

(52) U.S. Cl. CPC G05B 19/404; G05B 2219/33099

(57) ABSTRACT

Disclosed is a method, a device for machine tool accuracy compensation, a storage medium, and an electronic device. The method includes obtaining actual TCP 3D coordinates of a spherical head when A and B swivel heads of a BA double-swivel-head five-axis machine tool are at an actual swing position; obtaining vector difference information in each coordinate axis direction according to reference TCP 3D coordinates and the actual TCP 3D coordinates; and obtaining a target compensation value according to a parameter compensation value of the BA double-swivel-head five-axis machine tool and the vector difference information; the target compensation value being used for accuracy compensation of the BA double-swivel-head five-axis machine tool at the actual swing position. The present disclosure uses a vector difference between TCP coordinates at initial and actual positions as an accuracy deviation, combines an inherent parameter compensation value with the accuracy deviation for more accurate compensation.

### CROSS-REFERENCE TO RELATED APPLICATIONS

This application is a Continuation of International Application No. PCT/CN2023/130928, filed on Nov. 10, 2023, which claims priority to Chinese Patent Application No. 202310681855.4, filed on Jun. 9, 2023, the entire contents of each of which are hereby incorporated by reference.

### TECHNICAL FIELD

The present disclosure relates to a field of multi-axis machine tools, and in particular to a method and a device for machine tool accuracy compensation, a storage medium, and an electronic device.

### BACKGROUND

With the development of science and technology, computer numerical control (CNC) machine tools, as the cornerstone of industrial manufacturing, have undergone continuous iterations in structural design and functional optimization. The five-axis simultaneous machining technology has reached a high level of maturity. Rotation tool center point (RTCP) accuracy, as a core accuracy indicator of high-end CNC machine tools, directly affects the machining quality of the CNC machine tools.

Currently, detection of RTCP accuracy of machine tools is typically performed manually using tools such as dial indicators and calibration bars. This approach suffers from limited detection accuracy and low efficiency. Consequently, the compensation quality based on the detection results is relatively low, and the working effect of the machine tool is greatly reduced.

Therefore, a method and a device for machine tool accuracy compensation, a storage medium, and an electronic device are provided, aiming to solve the problem of low quality of machine tool accuracy compensation.

### SUMMARY

One or more embodiments of the present disclosure provide a method for machine tool accuracy compensation, applied to a device for machine tool accuracy compensation, wherein the device includes a calibration bar and a probe, the calibration bar includes a spherical head, the probe is installed on a worktable of a BA double-swivel-head five-axis machine tool, the calibration bar is installed in a tool magazine, and the method comprises: obtaining, using the probe, actual tool center point (TCP) 3D coordinates of the spherical head when A and B swivel heads of the BA double-swivel-head five-axis machine tool are at an actual swing position; obtaining, using the probe, a reference TCP X-axis coordinate and a reference TCP Y-axis coordinate when the A and B swivel heads of the BA double-swivel-head five-axis machine tool are at an initial position; moving a linear axis of the BA double-swivel-head five-axis machine tool to cause the probe to be located at a position having coordinates identical to the reference TCP X-axis coordinate and the reference TCP Y-axis coordinate to obtain a top Z-axis coordinate of the spherical head; obtaining a reference TCP Z-axis coordinate according to a distance from a rotation center to a spindle end face and the top Z-axis coordinate of the spherical head; obtaining reference TCP 3D coordinates according to the reference TCP X-axis coordinate, the reference TCP Y-axis coordinate, and the reference TCP Z-axis coordinate; obtaining vector difference information in each coordinate axis direction according to the reference TCP 3D coordinates and the actual TCP 3D coordinates, respectively; and obtaining a target compensation value according to a parameter compensation value of the BA double-swivel-head five-axis machine tool and the vector difference information; wherein the target compensation value is used for accuracy compensation of the BA double-swivel-head five-axis machine tool at the actual swing position.

One or more embodiments of the present disclosure provide a device for machine tool accuracy compensation applying the method for machine tool accuracy compensation, wherein, the device includes the calibration bar and the probe, the calibration bar includes the spherical head, the probe is installed on the worktable of the BA double-swivel-head five-axis machine tool, the calibration bar is installed in the tool magazine, and the device further comprises: a measurement module, configured to use the probe to obtain the actual TCP 3D coordinates of the spherical head when the A and B swivel heads of the BA double-swivel-head five-axis machine tool are at the actual swing position; the measurement module is configured to use the probe to obtain the reference TCP X-axis coordinate and the reference TCP Y-axis coordinate when the A and B swivel heads of the BA double-swivel-head five-axis machine tool are at the initial position; move the linear axis of the BA double-swivel-head five-axis machine tool to cause the probe to be located at the position having coordinates identical to the reference TCP X-axis coordinate and the reference TCP Y-axis coordinate to obtain the top Z-axis coordinate of the spherical head; obtain the reference TCP Z-axis coordinate according to the distance from the rotation center to the spindle end face and the top Z-axis coordinate of the spherical head; and obtain the reference TCP 3D coordinates according to the reference TCP X-axis coordinate, the reference TCP Y-axis coordinate, and the reference TCP Z-axis coordinate; a vector difference obtaining module, configured to obtain the vector difference information in each coordinate axis direction according to the reference TCP 3D coordinates and the actual TCP 3D coordinates, respectively; and a compensation module, configured to obtain the target compensation value according to the parameter compensation value of the BA double-swivel-head five-axis machine tool and the vector difference information; wherein the target compensation value is used for accuracy compensation of the BA double-swivel-head five-axis machine tool at the actual swing position.

One or more embodiments of the present disclosure provide a non-transitory computer-readable storage medium, storing a computer program, wherein, the computer program, when loaded and executed by a processor, implements the method for machine tool accuracy compensation.

One or more embodiments of the present disclosure provide an electronic device, comprising a processor and a memory, wherein: the memory is configured to store a computer program; the processor is configured to load and execute the computer program, to cause the electronic device to execute the method for machine tool accuracy compensation.

### BRIEF DESCRIPTION OF THE DRAWINGS

FIG. 1 is a schematic diagram illustrating a structure of an electronic device in a hardware operating environment according to some embodiments of the present disclosure.

FIG. 2 is a schematic flowchart illustrating an exemplary process for machine tool accuracy compensation according to some embodiments of the present disclosure.

FIG. 3 is a block diagram illustrating a device for machine tool accuracy compensation according to some embodiments of the present disclosure.

FIG. 4 is a schematic diagram illustrating an application scenario of a method for machine tool accuracy compensation according to some embodiments of the present disclosure.

FIG. 5 is a schematic diagram illustrating a principle of obtaining a distance from a rotation center to a spindle end face in a method for machine tool accuracy compensation according to some embodiments of the present disclosure.

FIG. 6 is a schematic diagram illustrating vector difference information in each coordinate axis direction in a method for machine tool accuracy compensation according to some embodiments of the present disclosure.

Reference signs in the drawings: 101—processor, 102—communication bus, 103—network interface, 104—user interface, 105—memory, 1—spherical head, 2—probe, 3—probe fixing base, 4—worktable.

### DETAILED DESCRIPTION

It should be understood that some embodiments described herein are merely used to explain the present disclosure and are not intended to limit the present disclosure.

A main solution of the embodiments of the present disclosure includes: providing a method and a system for machine tool accuracy compensation, a storage medium, and an electronic device. The method includes: obtaining, using a probe, actual TCP 3D coordinates of a spherical head when A and B swivel heads of a BA double-swivel-head five-axis machine tool are at an actual swing position; obtaining vector difference information in each coordinate axis direction according to reference TCP 3D coordinates and the actual TCP 3D coordinates, respectively; wherein the reference TCP 3D coordinates are obtained when the A and B swivel heads of the BA double-swivel-head five-axis machine tool are at an initial position; obtaining a target compensation value according to a parameter compensation value of the BA double-swivel-head five-axis machine tool and the vector difference information; wherein the target compensation value is used for accuracy compensation of the BA double-swivel-head five-axis machine tool at the actual swing position.

With the ongoing advancement of science and technology, CNC machine tools, as the cornerstone of industrial manufacturing, have undergone continuous iterations in structural design and functional optimization. The five-axis simultaneous machining technology has reached a high level of maturity. Rotation tool center point (RTCP) accuracy, as a core accuracy indicator of high-end CNC machine tools, directly affects the machining quality of the CNC machine tools. In recent years, major domestic machine tool manufacturers in China have successively introduced aluminum alloy processing production lines built with 3-PRS parallel-kinematic CNC machine tools for processing large and complex aviation structural components. The machine tool structure is a horizontal machining center, the swivel head is of a BA-type structure, and three linear axes are used for independent motion to simulate a swinging action. A rotation center is a rotation tool center point (RTCP). Parallel structure machine tools are highly recognized by aviation enterprises due to their high efficiency and high-precision machining performance, and are well applied in the aviation manufacturing industry.

Currently, detection of RTCP accuracy of parallel structure machine tools usually uses a calibration bar, a dial indicator, or other tools with similar functions, relying on professionals to perform manual detection. Manual repeated adjustment of a dial indicator bracket and reading of the dial indicator are required. Overall detection and compensation steps are relatively cumbersome, which easily causes manual detection errors, and the measurement time is long. The industry is actively seeking solutions, such as:

Application No.: CN202022963885.9 provides a device for rapidly detecting RTCP accuracy of a five-axis machine tool. The device uses three dial indicators which are respectively disposed in the X, Y, and Z directions to simultaneously detect vector differences in the three directions of X, Y, and Z. However, this detection manner is similar to the traditional manner, and the accuracy requirement for setting up the dial indicators is too high, and the operation is relatively cumbersome.

Application No.: CN201810699394.2 provides an RTCP accuracy compensation method for a five-axis laser processing device; Application No.: CN202110182396.6 provides a method for compensating structural parameter errors of a rotary axis of a five-axis CNC machine tool. Both technical solutions detect the vector deviation of each axis using corresponding tooling and a displacement sensor. This manner relies on tooling and the displacement sensor for detection, the operation is cumbersome, the requirement for debugging personnel is too high, automatic measurement cannot be achieved, and it is only suitable for small-scale promotion.

Therefore, to change the current situation of low manual detection efficiency and large errors during manual detection and compensation, and to stabilize detection results to improve the quality of compensation accuracy, the present disclosure provides a solution. A probe is used to replace manual detection. Using TCP coordinates of the swivel head at an initial position as a reference, the TCP coordinates of the swivel head at an actual swing position and the reference coordinates are used to obtain vector difference information in each coordinate axis direction in space, i.e., achieving accuracy detection of the machine tool, and accurately and efficiently obtaining the accuracy deviation of the machine tool. Since an automated machine tool has a self-compensation function, by combining an inherent parameter compensation value of the machine tool with the actually obtained accuracy deviation, the error of using the inherent parameter compensation value for compensation alone is avoided, and the target compensation value is comprehensively obtained to achieve more accurate compensation, effectively improving the quality of machine tool accuracy compensation.

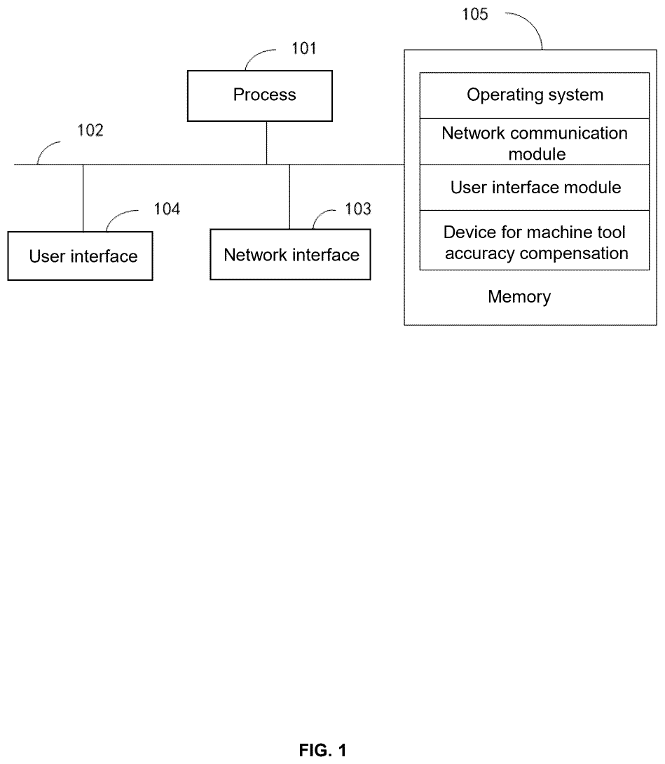

Referring to FIG. 1, FIG. 1 is a schematic diagram illustrating a structure of an electronic device in a hardware operating environment according to some embodiments of the present disclosure. The electronic device may include: a processor 101, such as a Central Processing Unit (CPU), a communication bus 102, a user interface 104, a network interface 103, and a memory 105. The communication bus 102 is configured to implement connection and communication between these components. The user interface 104 may include a display and an input unit such as a keyboard. In some embodiments, the user interface 104 may further include a standard wired interface and a wireless interface. The network interface 103 may include a standard wired interface and a wireless interface (such as a Wireless-Fidelity (WI-FI) interface). The memory 105 may be a storage device independent of the aforementioned processor 101. The memory 105 may be a high-speed random access memory (RAM) or a stable non-volatile memory (NVM), such as at least one disk storage. The processor 101 may be a general-purpose processor, including a central processing unit, a network processor, etc., or may be a digital signal processor, an application-specific integrated circuit, a field-programmable gate array, or other programmable logic device, a discrete gate or transistor logic device, or a discrete hardware component.

Those skilled in the art may understand that the structure shown in FIG. 1 does not constitute a limitation on the electronic device, and the electronic device may include more or fewer components than those shown in the figure, or combine some components, or have different component arrangements.

As shown in FIG. 1, an operating system, a data storage module, a network communication module, a user interface module, and an electronic program may be included in the memory 105 as a storage medium.

In the electronic device shown in FIG. 1, the network interface 103 is mainly used for data communication with a network server. The user interface 104 is mainly used for data interaction with a user. The processor 101 and the memory 105 in the present disclosure may be disposed in the electronic device. The electronic device invokes the device for machine tool accuracy compensation stored in the memory 105 through the processor 101 and executes the method for machine tool accuracy compensation provided by the embodiments of the present disclosure.

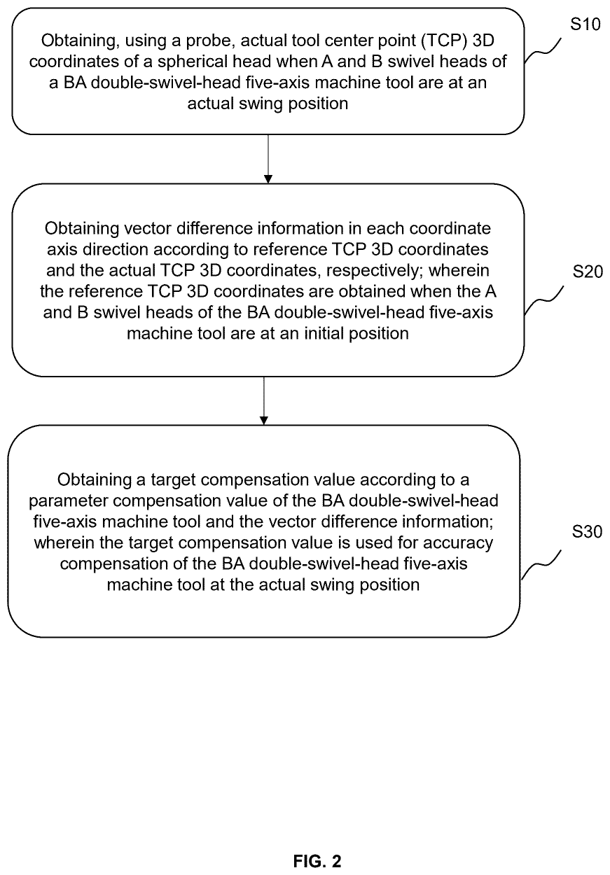

Referring to a schematic flowchart illustrating an exemplary process for machine tool accuracy compensation according to some embodiments of the present disclosure shown in FIG. 2, based on the hardware device of the aforementioned embodiments, embodiments of the present disclosure provide a method for machine tool accuracy compensation, applied to a device for machine tool accuracy compensation. The device includes a calibration bar and a probe. The calibration bar includes a spherical head. The probe is installed on a worktable of a BA double-swivel-head five-axis machine tool (hereinafter referred to as the machine tool). The calibration bar is installed in a tool magazine. The method includes the following steps S10 to S30. Steps S10 to S30 are executed by the processor.

The device for machine tool accuracy compensation refers to a system or a combination of tools configured to implement the method for machine tool accuracy compensation. Hardware components of the device for machine tool accuracy compensation include the calibration bar and the probe, and also integrate or connect to an electronic device capable of executing the method for machine tool accuracy compensation. For more related descriptions about the electronic device, refer to the corresponding content above.

The calibration bar is a detection rod installed in the tool magazine or on a tool holder, and the spherical head is installed at an end thereof as a measurement reference.

The spherical head refers to a standard sphere on the calibration bar, serving as a target point during measurement, and a center thereof is a TCP. In some embodiments, the calibration bar is configured to simulate a tool position and is installed on a tool magazine of a machining center.

In some embodiments, the calibration bar is fixed at a tool magazine position to simulate a tool endpoint, so that the spherical head is at a measurable position reachable by the probe. When the tool magazine position cannot be used, the calibration bar may also be temporarily clamped on the tool holder or a spindle to reproduce measurement conditions.

The tool magazine refers to a device in a CNC machine tool used for storing and managing a plurality of tools or tooling. In some embodiments, the calibration bar is installed in the tool magazine and may be called to the spindle for measurement or unloaded from the spindle for storage through an automatic tool changing system of the machine tool.

The BA double-swivel-head machine tool refers to a machine tool having three linear axes and two rotary axes, A and B. The A and B swivel heads (hereinafter referred to as the swivel heads) respectively control rotation of the tool in one rotary direction. This structure may achieve complex surface machining by changing a tool attitude during a machining process.

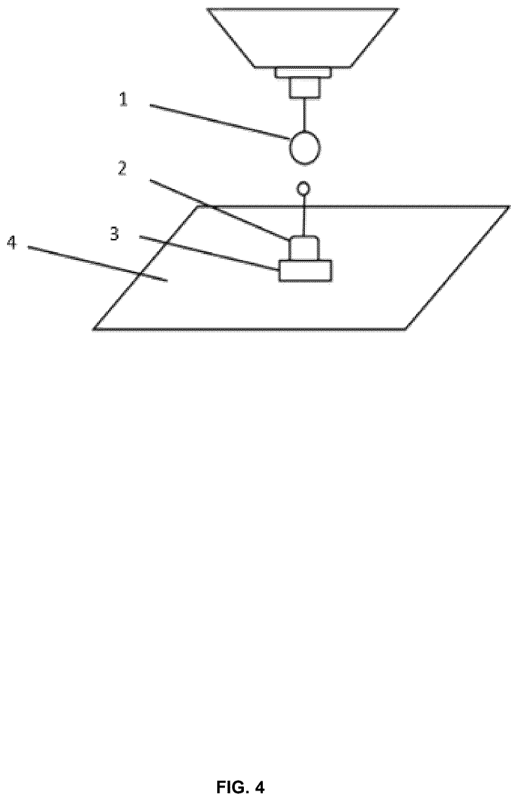

As shown in a schematic diagram illustrating an application scenario of a method for machine tool accuracy compensation according to some embodiments of the present disclosure in FIG. 4, a probe 2 installed on a worktable 4 of a machine tool may detect a position of a spherical head 1 of a calibration bar cooperating therewith.

In S10, obtaining, using the probe, actual TCP 3D coordinates of the spherical head when A and B swivel heads of the BA double-swivel-head five-axis machine tool are at an actual swing position.

The probe refers to a measurement sensing device installed on the worktable or at an appropriate position of the machine tool. For example, the probe includes a contact trigger probe, a contact scanning probe, and a laser or optical non-contact probe, etc., used to obtain spatial coordinates of surface points of the spherical head in a machine tool coordinate system.

As shown in FIG. 4, the probe 2 may be installed on the worktable 4 through a probe fixing base 3.

The actual swing position refers to any working position of the A and B swivel heads of the machine tool after a certain angle of swing has occurred during machining or measurement, which is different from an initial position.

The initial position refers to a preset reference position when swing angles of the A and B swivel heads of the machine tool are both zero.

In some embodiments, the initial position is a position as shown in the scenario in FIG. 4, where an axis of the calibration bar coincides with an axis of the spindle and is perpendicular to the worktable 4, i.e., a position when the swing angles of the A and B swivel heads are both zero.

The actual TCP 3D coordinates refer to TCP 3D coordinates of the spherical head obtained using the probe when the A and B swivel heads are at the actual swing position.

In actual use, the A and B swivel heads are connected to the spindle. The actual position refers to a position after the A and B swivel heads have rotated by a certain angle when the tool needs to adjust the angle during the machining process. At this time, according to the probe, 3D coordinates of the spherical head at the actual position (i.e., the actual TCP 3D coordinates) in the machine tool coordinate system may be obtained. The acquisition principle is similar to a laser tracker measuring position coordinates of a target ball.

In some embodiments, the A and B swivel heads of the machine tool are driven to move to the actual swing position to be compensated. Using the probe installed on the worktable to perform contact measurement with the spherical head of the calibration bar installed in the tool magazine, 3D coordinates of the spherical head at this position in the machine tool coordinate system may be obtained, and the actual TCP 3D coordinates may be obtained.

In S20, obtaining vector difference information in each coordinate axis direction according to reference TCP 3D coordinates and the actual TCP 3D coordinates, respectively; wherein the reference TCP 3D coordinates are obtained when the A and B swivel heads of the BA double-swivel-head five-axis machine tool are at the initial position.

The reference TCP 3D coordinates refer to TCP 3D coordinates of the spherical head obtained using the probe when the A and B swivel heads of the BA double-swivel-head five-axis machine tool are at the initial position, which serve as reference coordinates for measuring accuracy deviation.

Using the same manner as the initial position measurement, the probe may be configured to measure the 3D coordinates of the spherical head 1 at this position in the machine tool coordinate system, i.e., the reference TCP 3D coordinates. For more descriptions about obtaining the reference TCP 3D coordinates, refer to related content below.

The vector difference information refers to a difference between the actual TCP 3D coordinates and the reference TCP 3D coordinates on a corresponding coordinate axis.

In some embodiments, the probe is configured to measure the TCP 3D coordinates of the spherical head when the A and B swivel heads are at the initial position, to obtain a reference TCP X-axis coordinate and a reference TCP Y-axis coordinate. Then, by moving the linear axis, a top Z-axis coordinate of the spherical head is measured. Combined with a distance from a rotation center to a spindle end face, a spherical head radius, and a probe radius, a reference TCP Z-axis coordinate is determined. By comparing the actual TCP 3D coordinates and the reference TCP 3D coordinates, a coordinate difference in each coordinate axis direction is respectively determined, i.e., the vector difference information in each coordinate axis direction. The spherical head radius and the probe radius are obtained by stored data of a processor calling system or by reading input data.

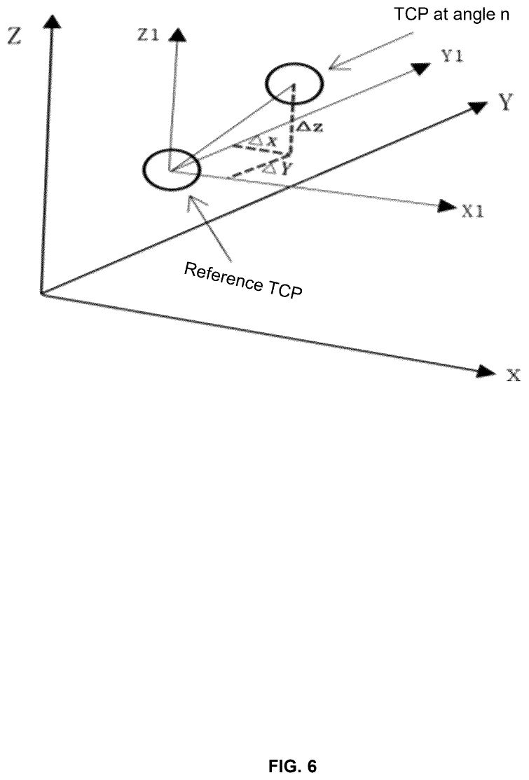

FIG. 6 is a schematic diagram illustrating vector difference information in each coordinate axis direction in a method for machine tool accuracy compensation according to some embodiments of the present disclosure. A machine tool coordinate system is a coordinate system represented by X, Y, and Z axes shown in FIG. 6. Vector difference information in each coordinate axis direction is a difference between reference TCP 3D coordinates and actual TCP 3D coordinates in the coordinate axis direction. As shown in FIG. 6, a reference coordinate system X1Y1Z1 is established with a reference TCP as an origin. Each coordinate axis of the reference coordinate system corresponds to a coordinate axis of the machine tool coordinate system. Angle n refers to an actual position of the tool center point when swivel heads are at given swing angles. A corresponding vector difference is a difference between corresponding coordinate values, recorded as ΔX, ΔY, and ΔZ, which are accuracy deviations of the BA double-swivel-head five-axis machine tool. For example, for the reference TCP 3D coordinates (X1, Y1, Z1) and the actual TCP 3D coordinates (BALL_Xn, BALL_Yn, BALL_Zn), the vector difference in each coordinate axis direction is determined as follows: ΔXn=BALL_Xn-X1, ΔYn=BALL_Yn-Y1, and ΔZn=BALL_Zn-Z1.

In S30, obtaining a target compensation value according to a parameter compensation value of the BA double-swivel-head five-axis machine tool and the vector difference information; wherein the target compensation value is used for accuracy compensation of the BA double-swivel-head five-axis machine tool at the actual swing position.

The parameter compensation value refers to an inherent compensation value stored by a numerical control machine tool using its own built-in program or firmware. According to the parameter compensation value, a processor is configured to invoke a program for compensation according to an actual machining position.

The target compensation value refers to a new and more accurate compensation value obtained by combining the parameter compensation value of the BA double-swivel-head five-axis machine tool with actually measured vector difference information.

In some embodiments, the processor is configured to read an inherent parameter compensation value of the BA double-swivel-head five-axis machine tool. The target compensation value is determined by combining (algebraically adding) the read parameter compensation value with measured vector difference information. For example, the target compensation value=the parameter compensation value+the vector difference information. The target compensation value is used for accuracy compensation of the BA double-swivel-head five-axis machine tool at the actual swing position.

In some embodiments, the parameter compensation value of the BA double-swivel-head five-axis machine tool is a compensation value used by the numerical control machine tool to perform compensation using its own built-in program. The parameter compensation value is a value with universal adaptability, and is used to invoke the program for compensation according to a corresponding parameter compensation value based on the actual machining position. However, in practice, during a machining process, rotation of a tool may affect the position of the tool center point. The inherent parameter compensation of the machine tool cannot compensate for this part of error. Therefore, the vector difference information is combined with the parameter compensation value of the BA double-swivel-head five-axis machine tool to avoid an excessively large error caused by one-sided compensation. A part station and a TCP deviation are comprehensively considered to accurately compensate for accuracy of the BA double-swivel-head five-axis machine tool at the actual swing position, thereby improving an operation effect of the machine tool.

In the embodiment, the probe replaces manual detection. Taking TCP coordinates when the swivel heads are at the initial position as reference coordinates, the vector difference information in each coordinate axis direction in space is obtained based on TCP coordinates when the swivel heads are at the actual swing position and the reference coordinates, that is, the accuracy detection of the BA double-swivel-head five-axis machine tool is implemented, which can accurately and efficiently obtain an accuracy deviation of the machine tool. Since the automated machine tool has a self-compensation function, the inherent parameter compensation value of the machine tool is combined with the actually obtained accuracy deviation to avoid an excessively large error caused by separate compensation using the inherent parameter compensation value and to obtain the target compensation value to achieve more accurate compensation. All detection and compensation actions are programmed and stored in an internal controller of the machine tool. they are automatically executed by means of program invocation to avoid manual intervention and reduce human errors, which makes the accuracy detection efficiency higher and more stable, effectively improves the quality of machine tool accuracy compensation, thereby guaranteeing the part machining quality.

In one embodiment, before obtaining the vector difference information in each coordinate axis direction respectively according to the reference TCP 3D coordinates and the actual TCP 3D coordinates, the method for machine tool accuracy compensation further includes:
obtaining, using the probe, a reference TCP X-axis coordinate and a reference TCP Y-axis coordinate when the A and B swivel heads of the BA double-swivel-head five-axis machine tool are at the initial position;
moving a linear axis of the BA double-swivel-head five-axis machine tool to cause the probe to be located at a position having coordinates identical to the reference TCP X-axis coordinate and the reference TCP Y-axis coordinate to obtain a top Z-axis coordinate of the spherical head;
obtaining a reference TCP Z-axis coordinate according to a distance from a rotation center to a spindle end face and the top Z-axis coordinate of the spherical head; and
obtaining reference TCP 3D coordinates according to the reference TCP X-axis coordinate, the reference TCP Y-axis coordinate, and the reference TCP Z-axis coordinate.

In some embodiments, the processor is configured to set the A and B swivel heads of the BA double-swivel-head five-axis machine tool at the initial position, use the probe installed on the worktable to measure the spherical head of the calibration bar located on the spindle (the tool magazine), and, without moving the Z axis, determine projection coordinates of the tool center point on a cross-section by means of four-point contact measurement along the X axis and the Y axis (e.g., X+, X−, Y+, Y−) or circle fitting, i.e., obtain the reference TCP X-axis coordinate and the reference TCP Y-axis coordinate.

In some embodiments, the processor is configured to keep the swivel heads of the BA double-swivel-head five-axis machine tool at the initial position, move the X axis and the Y axis to cause the probe to be precisely aligned with the reference TCP X-axis coordinate and the reference TCP Y-axis coordinate, then move the Z axis to cause the probe to contact a topmost point of the spherical head along the Z-axis direction, and record a Z-axis coordinate of the topmost point as the top Z-axis coordinate BALL_Z0 of the spherical head.

In some embodiments, the processor is configured to use a geometric relationship and known measurement dimensions to obtain the reference TCP Z-axis coordinate BALL_Z through a mathematical manner. For more descriptions about obtaining the reference TCP Z-axis coordinate, refer to related content below.

In some embodiments, the processor is configured to integrate the reference TCP X-axis coordinate and the reference TCP Y-axis coordinate with the reference TCP Z-axis coordinate to obtain the reference TCP 3D coordinates (BALL_X, BALL_Y, BALL_Z) of the BA double-swivel-head five-axis machine tool at the initial position.

In some embodiments, since it is in a spatial coordinate system, the reference TCP 3D coordinates include X, Y, and Z three-axis coordinates. At the initial position, an axis of the spindle is perpendicular to the worktable 4. Therefore, the probe 2 is located on the axis. Point coordinates are the same on the X and Y axes, and differ only in the Z-axis direction. Therefore, the reference TCP X-axis coordinate and the reference TCP Y-axis coordinate are obtained first, then, by moving the linear axis of the BA double-swivel-head five-axis machine tool, the position of the probe 2 is adjusted to the reference TCP position to measure the Z-axis coordinate of the spherical head. Since both the probe 2 and the spherical head 1 have a certain volume and cannot be equivalently regarded as points, the reference TCP Z-axis coordinate may only be determined by following operations. The following operations include: measuring the top Z-axis coordinate of the spherical head 1 measured by contact, and after measurement, determining the reference TCP Z-axis coordinate according to a line segment relationship. The line segment relationship includes that an absolute value of the reference TCP Z-axis coordinate is equal to an absolute value of the measured top Z-axis coordinate of the spherical head minus the distance from the rotation center to the spindle end face, the spherical head radius, and the probe radius. In this way, the coordinate of the reference TCP on each coordinate axis has been obtained, and the reference TCP 3D coordinates may be obtained.

By first obtaining horizontal coordinates of the reference TCP at an initial posture, then precisely positioning the probe to measure the top of the spherical head, and combining it with a clear geometric correction formula to determine the Z-axis coordinate of the reference TCP to form a complete 3D reference, consistency and traceability between the reference and actual posture measurement are ensured. Coordinate alignment errors and probe geometric offset effects on results are reduced. Reliable reference data is provided for subsequent vector difference determination and generation of the target compensation value, thereby significantly improving accuracy of machine tool posture-related Z-direction compensation and engineering implementation of the compensation process.

In one embodiment, before obtaining the reference TCP Z-axis coordinate according to the distance from the rotation center to the spindle end face and the top Z-axis coordinate of the spherical head, the method further includes:
within swinging ranges of the A and B swivel heads of the BA double-swivel-head five-axis machine tool, obtaining first TCP coordinates and second TCP coordinates of the spherical head at symmetrical swing positions about the initial position of the A and B swivel heads;
obtaining the distance from the rotation center to the spindle end face according to a length of the calibration bar, single-swing angles of the A and B swivel heads, the first TCP coordinates, and the second TCP coordinates.

The swinging ranges of the A and B swivel heads refer to a set of physical rotation angles achievable by the A axis and the B axis of the BA double-swivel-head five-axis machine tool. In some embodiments, the swinging ranges of the A axis and the B axis are centered on their respective rotation center axes and determined relative to the initial position (0°) in the machine tool coordinate system. For example, the swinging range of the A axis is [+120°, −120°].

The symmetrical swing positions refer to positions on both sides of the initial position, where the swivel heads of the machine tool are located, having swing angles with the same absolute value. For example, taking the B axis as an example, +30° and −30° are a pair of symmetrical swing positions.

The first TCP coordinates and the second TCP coordinates refer to 3D TCP coordinates of the spherical head at a pair of symmetrical swing positions. For example, the first TCP coordinates C1 are at +30°, and the second TCP coordinates C2 are at −30°. The first TCP coordinates and the second TCP coordinates are obtained using the probe.

The length of the calibration bar refers to an effective length L from a fixed point of the calibration bar to a center of the spherical head, which is a known or calibrated geometric quantity.

The single-swing angle refers to an angle θ (i.e., +0 or −0) by which the swivel head swings from the initial position to one of any symmetrical swing positions. The single-swing angle is configured to be directly read or set by the processor.

The distance (λ) from the rotation center to the spindle end face refers to a distance between a rotation center axis of the swivel head and the spindle end face of the BA double-swivel-head five-axis machine tool. This distance is a geometric parameter affecting accuracy of the BA double-swivel-head five-axis machine tool.

In some embodiments, the processor is configured to determine the distance λ from the rotation center to the spindle end face according to the length of the calibration bar, the single-swing angles of the swivel heads, the first TCP coordinates, and the second TCP coordinates. For more descriptions about obtaining the distance from the rotation center to the spindle end face, refer to related content below. In other embodiments, the distance λ from the rotation center to the spindle end face is configured to be obtained by system preset, input after measurement, or any other feasible manner.

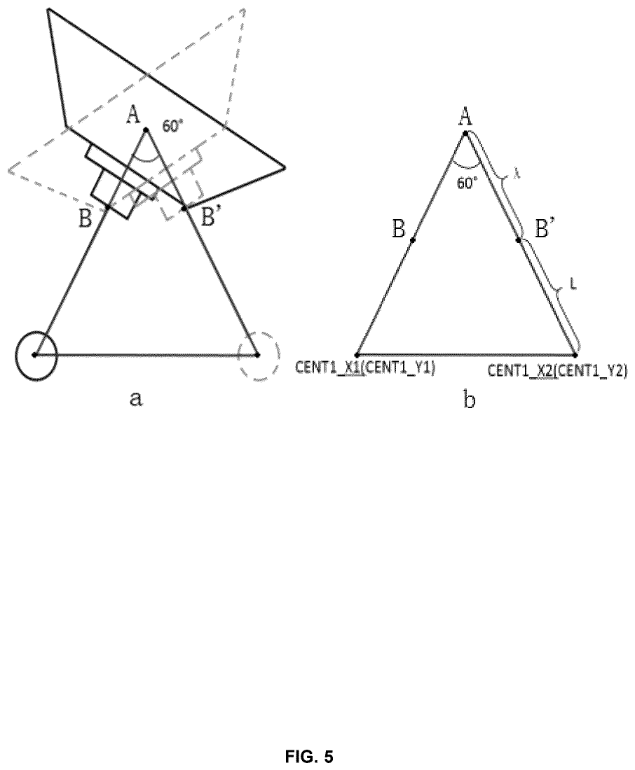

FIG. 5 is a schematic diagram illustrating a principle of obtaining a distance from a rotation center to a spindle end face in a method for machine tool accuracy compensation according to some embodiments of the present disclosure. In some embodiments, the distance from the rotation center to the spindle end face is verified to improve accuracy. As shown in diagram (a) of FIG. 5, based on any one swivel head, it undergoes symmetrical swinging relative to the initial position. A rotation center point A and tool center points of the two swing positions form an isosceles triangle. Center points of the spindle end face of the two swings are B and B′, respectively. An extracted triangle is shown in diagram (b) of FIG. 5. When the swing angle is configured to be manually controlled, a base of the virtual isosceles triangle is obtained according to a coordinate difference of the tool center points in the swinging direction under the two swings. A leg length of the virtual isosceles triangle is a sum of the distance from the rotation center to the spindle end face and the length of the calibration bar. Given the single-swing angle and a length of a side opposite the angle, a hypotenuse length is obtained according to its sine value in a right triangle. Then, the distance from the rotation center to the spindle end face is obtained by subtracting the known length of the calibration bar from the hypotenuse length. As shown in FIG. 5, the single-swing angle is 30°. The formed virtual triangle is an equilateral triangle. As a special triangle with three equal sides, a side length is obtained from the coordinate difference. Then, the sum of the distance from the rotation center to the spindle end face and the length of the calibration bar has been obtained. In this case, it is not necessary to use the angle for calculation.

In one embodiment, obtaining the distance from the rotation center to the spindle end face according to the length of the calibration bar, the single-swing angles of the A and B swivel heads, the first TCP coordinates, and the second TCP coordinates, includes:
respectively calculating, according to the length of the calibration bar, the single-swing angles of the A and B swivel heads, the first TCP coordinates, and the second TCP coordinates, the distance from the rotation center to the spindle end face within the swinging ranges of the A and B swivel heads, to obtain a distance from a first rotation center to the spindle end face and a distance from a second rotation center to the spindle end face; and
obtaining, according to an average value of the distance from the first rotation center to the spindle end face and the distance from the second rotation center to the spindle end face, the distance from the rotation center to the spindle end face.

The distance from the first rotation center to the spindle end face and the distance from the second rotation center to the spindle end face respectively refer to effective axial distances from respective rotation centers of two different swivel heads of the machine tool (e.g., the A and B swivel heads) to the spindle end face, which are obtained through measurement and calculation according to geometric relationships under conditions where the two different swivel heads of the machine tool serve as rotation units. The distance from the first rotation center to the spindle end face is denoted as λ1, and the distance from the second rotation center to the spindle end face is denoted as λ2. λ1 and λ2 reflect differences in geometric positions of the rotation centers relative to the spindle end face under different swivel head structures or different swinging directions.

In some embodiments, at least two sets of different swing angles symmetrical about the initial position are selected to measure the first TCP coordinates and the second TCP coordinates of the spherical head, respectively. According to geometric relationships and trigonometric principles, the distance from the first rotation center to the spindle end face and the distance from the second rotation center to the spindle end face are independently determined using each set of symmetrical measurement data (the length of the calibration bar, the single-swing angle, and a coordinate difference). The coordinate difference refers to a difference, in each coordinate axis direction, between the actually measured first TCP coordinates and second TCP coordinates and their corresponding reference TCP 3D coordinates, respectively.

In some embodiments, after obtaining λ1 and λ2 respectively, a final distance λ from the rotation center to the spindle end face is obtained through arithmetic averaging: λ=(λ1+λ2)/2, so as to utilize redundant information from the two swivel heads to reduce the impact of measurement errors from a single swivel head.

In some embodiments, the processor may determine the final distance λ from the rotation center to the spindle end face λ using a weighted average based on a confidence level of each measurement result or a variance of repeated measurements: λ=(w1·λ1+w2·λ2)/(w1+w2), where weights w1 and w2 may be obtained by the processor calling system-stored data.

It should be noted that the symmetrical swing manner used in the embodiments of the present disclosure for determining the distance λ from the rotation center to the spindle end face does not require a highly accurate known value of λ; on the contrary, the present disclosure may perform iterative fine calibration based on a rough initial value obtained from factory nominal values or mechanical measurement, thus circumventing the circular dependency inherent in methods that require pre-calibrated parameters for the calibration procedure itself. When necessary, an external high-precision measuring instrument (e.g., a coordinate measuring machine (CMM), a laser tracker, a precision height gauge, etc.) may be used to perform initial calibration of λ or the tool center point, so as to achieve a higher precision first calibration.

In some embodiments, because it is a double-swivel-head machine tool capable of swinging in two directions, in order to improve detection accuracy, verification is performed by integrating multi-angle data. According to the same method described above, distance data from the two rotation centers to the spindle end face, i.e., the distance from the first rotation center to the spindle end face and the distance from the second rotation center to the spindle end face, are obtained based on the two swing angles. An average is determined from the two pieces of distance data to obtain a more accurate distance from the rotation center to the spindle end face, further enhancing the accuracy of precision detection and compensation.

One or more embodiments of the present disclosure provide a process for accurately and programmatically measuring the distance from the rotation center to the spindle end face. This distance is a basis for subsequently calculating the reference TCP Z-axis coordinate, thereby providing a high-precision geometric benchmark for subsequent accuracy compensation. Using the calibration bar and the probe, the geometric parameter determination process is automated by programmatically controlling the symmetrical swinging of the swivel head and automatically measuring coordinates, avoiding human errors and low reliability issues associated with traditional manual or simple gauge measurements.

In one embodiment, using the probe, actual TCP 3D coordinates of the spherical head when A and B swivel heads of the BA double-swivel-head five-axis machine tool are at an actual swing position, includes:
obtaining, using the probe and employing multi-layer roundness coordinate calculation, the actual TCP 3D coordinates of the spherical head when the A and B swivel heads of the BA double-swivel-head five-axis machine tool are at the actual swing position.

The multi-layer roundness coordinate calculation refers to a measurement and calculation manner that involves collecting circumferential points or equally angularly distributed points on a plurality of different height layers of the sphere perpendicular to the Z-axis of the BA double-swivel-head five-axis machine tool, determining the center of each layer respectively, and then synthesizing centers of all layers to determine a center of the overall sphere (i.e., the tool center point). Each height layer is referred to as a “layer” or “cross-section”. The inter-layer spacing and the count of points per layer may be set according to accuracy requirements.

For further description of the actual TCP 3D coordinates, please refer to the related content above.

In some embodiments, the A and B swivel heads of the BA double-swivel-head five-axis machine tool are driven to move to any target actual swing position. The probe is moved to approach the spherical head along the positive and negative directions of the X-axis and the Y-axis. A plurality of single-layer roundness coordinates at different Z-axis heights on the sphere are measured and acquired. The X-axis and Y-axis coordinates of the actual TCP 3D coordinates are finally obtained by averaging the plurality of single-layer roundness coordinates. The Z-axis coordinate of the actual TCP 3D coordinates may be obtained in a manner similar to that for the reference TCP Z-axis coordinate (i.e., using the top Z-axis coordinate, the distance from the rotation center to the spindle end face, the spherical head radius, and the probe radius).

Using the multi-layer roundness coordinate calculation to obtain the actual TCP effectively suppresses the impact of single-layer local defects or measurement point anomalies on the TCP determination. The robustness and accuracy of the TCP determination are improved through inter-layer averaging or global fitting. This manner is compatible with various probe types and measurement strategies, facilitating rapid and repeatable TCP measurement under production site conditions. Thereby, it provides reliable input for subsequent vector difference determination and compensation updates, significantly enhancing the disturbance resistance and engineering implementation of the compensation method.

In some embodiments, to reduce the impact of local accuracy errors on the surface of the spherical head 1, the embodiments of the present disclosure use the multi-layer roundness coordinate calculation to obtain the actual TCP 3D coordinates of the spherical head. The multi-layer roundness calculation also involves using the same TCP to measure roundness coordinates on circles of different radii to gradually approximate the actual sphere to be measured.

In some embodiments, using the probe and employing multi-layer roundness coordinate calculation to obtain the actual TCP 3D coordinates of the spherical head when the A and B swivel heads of the BA double-swivel-head five-axis machine tool are at the actual swing position includes:
obtaining, using the probe, multi-layer roundness coordinates on the spherical head when the A and B swivel heads of the BA double-swivel-head five-axis machine tool are at the actual swing position;
obtaining, according to an average value of roundness coordinates of each layer among the multi-layer roundness coordinates on the spherical head, a plurality of single-layer roundness coordinates; and
obtaining, according to an average value of the plurality of single-layer roundness coordinates, the actual TCP 3Dcoordinates of the spherical head.

The multi-layer roundness coordinates refer to a set of coordinates obtained through the probe at cross-sections of different Z-axis heights on the spherical head. Measuring the roundness coordinates of each layer typically includes measuring 3D coordinates of four or more sampling points measured by approaching the spherical head along the positive and negative directions of the X-axis and Y-axis (e.g., X+, X−, Y+, Y−).

In some embodiments, the swivel head of the BA double-swivel-head five-axis machine tool is driven to move to any actual swing position. The X, Y, and Z linear axes of the BA double-swivel-head five-axis machine tool are driven using the probe to measure the spherical head of the calibration bar. At a plurality of predetermined cross-sections of different Z-axis heights (e.g., Z1, Z2, Z3, etc.), the probe approaches the surface of the spherical head along the positive and negative directions of the X-axis and Y-axis, respectively, and trigger coordinates in each direction are recorded. Therefore, a plurality of sets of measurement point coordinates on the spherical head, i.e., the multi-layer roundness coordinates, are obtained.

The single-layer roundness coordinates refer to TCP coordinates of a circular cross-section of a certain Z-axis height obtained after processing multi-point roundness coordinate data measured on the circular cross-section.

In some embodiments, the multi-point roundness coordinate data of each layer is processed. For example, coordinates measured along the positive and negative directions of the X-axis and Y-axis on across-section of a certain Z-axis height (i.e., one layer) are arithmetically averaged or subjected to circle fitting calculation, thereby eliminating random errors and probe trigger errors in the measurement of the layer, and thus obtaining the average TCP coordinates of the roundness of the layer (i.e., the single-layer roundness coordinates). If m layers are measured for roundness, then m single-layer roundness coordinates are obtained.

In some embodiments, the processor performs secondary averaging or fitting processing on the plurality of single-layer roundness coordinates. For example, an average value is taken for the X-axis coordinates of all the single-layer roundness coordinates to obtain the final actual TCP X-axis coordinate; an average value is taken for the Y-axis coordinates of all the single-layer roundness coordinates to obtain the final actual TCP Y-axis coordinate. This secondary averaging process may eliminate the influence of local form errors of the sphere itself, as well as straightness errors and perpendicularity errors of the linear axes (X-axis and Y-axis) of the BA double-swivel-head five-axis machine tool on the determination of the TCP. The Z-axis coordinate of the actual TCP may be obtained according to other embodiments (e.g., using the top Z-axis coordinate, the length of the calibration bar, etc.).

In some embodiments, the roundness coordinates of each layer are roundness coordinates on the sphere measured by approaching the spherical head along the positive and negative directions of the X-axis and Y-axis respectively according to the swing position. Then, the precise actual TCP 3D coordinates are determined based on the average values of the coordinates in the X-axis direction and the Y-axis direction, respectively. However, it should be noted that since the multi-layer roundness coordinate calculation only focuses on the X-axis and Y-axis data on the sphere, this embodiment is used for obtaining the X-axis and Y-axis coordinates of the actual TCP 3D coordinates. The Z-axis coordinate of the actual TCP 3D coordinates may be obtained according to the manner described in the foregoing embodiments.

Using the multi-layer roundness coordinate calculation and obtaining the actual TCP through the synthesis of single-layer centers can effectively reduce errors caused by single-layer local defects or measurement point anomalies. The robustness and repeatability of TCP calculation are improved through inter-layer averaging or global fitting, thereby providing high-credibility input data for subsequent vector difference calculation and compensation updates. This approach balances measurement accuracy with on-site implementation efficiency, facilitating rapid and reliable detection and compensation of posture-dependent errors in production sites.

In one embodiment, after obtaining the vector difference information in each coordinate axis direction according to the reference TCP 3D coordinates and the actual TCP 3D coordinates, respectively, the method further includes:
determining whether the vector difference information in each coordinate axis direction is greater than a preset accuracy error threshold, and executing machine-tool alarm handling when the vector difference information in each coordinate axis direction is greater than the preset accuracy error threshold.

For further description of the vector difference information, please refer to the related content above.

The preset accuracy error threshold refers to a permissible error limit set in the processor in advance, used to determine whether the measured error is within a safe range for automatic compensation. The preset accuracy error threshold may be established based on machine tool specifications, machining tolerances, probe accuracy, and field experience.

In some embodiments, absolute values (ΔX, ΔY, ΔZ) of the vector difference information in each coordinate axis direction are compared with the preset accuracy error threshold XM. If any of ΔX>XM, ΔY>XM, or ΔZ>XM is satisfied, then the determination result is “yes” (the vector difference is greater than the preset accuracy error threshold), indicating that the current state of the BA double-swivel-head five-axis machine tool may have a serious fault or measurement system abnormality. Conversely, if the absolute values of all vector differences are not greater than the preset accuracy error threshold, then the determination result is “no”.

In some embodiments, in response to a determination that the determination result is “yes” (the vector difference is greater than the preset accuracy error threshold), the machine tool program immediately executes machine-tool alarm handling. The machine-tool alarm handling may include interrupting the current accuracy compensation program, stopping all operations of the BA double-swivel-head five-axis machine tool, displaying alarm information (e.g., “Precision deviation exceeds limit” or “System fault”) on an operation interface, and issuing a warning to an operator through audible and visual signals.

In some embodiments, because the BA double-swivel-head five-axis machine tool faces issues such as over-travel in actual operation, an excessively large vector difference reflects that a major fault has occurred in the machine tool's accuracy. Corrections made based on this vector difference might not be completed due to factors like over-travel in swing angle or linear axis. In this case, it is necessary to set a threshold to ensure safety, i.e., the preset accuracy error threshold. If the vector difference information exceeds the preset accuracy error threshold, the machine-tool alarm handling is required so that relevant personnel may perform maintenance.

In some embodiments, a safety threshold determination and alarm mechanism for accuracy deviation are introduced, giving the BA double-swivel-head five-axis machine tool a safety protection function when executing the accuracy compensation. Once a sudden fault in geometric parameters of the machine tool (such as collision, sensor failure, etc.) causes an abnormal increase in deviation, the system may stop promptly and issue an alarm, thereby preventing the continued use of abnormal data for compensation. This effectively avoids secondary losses such as product scrap or machine tool damage caused by erroneous compensation data. Simultaneously, by comparing with the preset accuracy error threshold, performance abnormalities under the current measurement posture of the machine tool can be quickly identified, providing maintenance personnel with a basis for preliminary fault localization.

In some embodiments, whether the vector difference information in each coordinate axis direction is greater than the preset accuracy error threshold is determined, and an accuracy compensation table is automatically invoked to execute accuracy compensation when the vector difference information in each coordinate axis direction is not greater than the preset accuracy error threshold.

For more descriptions of the vector difference information, the preset accuracy error threshold, and the determination process, refer to the related content described above.

The accuracy compensation table refers to a data matrix or list stored in a numerical control (NC) system of the BA double-swivel-head five-axis machine tool or a related electronic device. The accuracy compensation table records target compensation values in corresponding coordinate axis directions under different swing angle postures of the BA double-swivel-head five-axis machine tool (e.g., COMP_VALUE [n, 0/1/2]).

Accuracy compensation refers to reading, by the numerical control system of the BA double-swivel-head five-axis machine tool, a target compensation value in a corresponding coordinate axis direction under a current swing angle posture, and applying the target compensation value to an axis control instruction of the BA double-swivel-head five-axis machine tool, thereby correcting an actual position of the tool center point or a rotation center of the swivel head to be closer to a theoretical position in real time.

In some embodiments, in response to a determination that the vector difference information is not greater than the preset accuracy error threshold, the machine tool system confirms that a current accuracy deviation is normal, and automatically reads a target compensation value corresponding to a current actual swing position from a memory or a storage medium. Subsequently, the target compensation value is sent to a corresponding servo drive unit through a control system, to correct the coordinates of the tool center point or the rotation center of the BA double-swivel-head five-axis machine tool in real time, thereby performing compensation for accuracy of the BA double-swivel-head five-axis machine tool. An entire process of invoking and performing the accuracy compensation is automatically completed by the system without manual intervention.

In some embodiments, in response to a determination that the vector difference information is not greater than the preset accuracy error threshold, the processor may perform automatic correction. The correction may be performed based on a pre-generated accuracy compensation table. The accuracy compensation table is generated according to a swing angle, a corresponding parameter compensation value, and corresponding vector difference information. That is, each swing angle corresponds to a specific target compensation value. The accuracy compensation for the BA double-swivel-head five-axis machine tool may be implemented by simply invoking an internal program of the machine tool.

Automatically invoking the accuracy compensation table and performing the accuracy compensation in response to determining that the vector difference information in each coordinate axis direction is not greater than the preset accuracy error threshold may implement an integrated closed loop of measurement, calculation, and correction, significantly shorten an adjustment period, and reduce uncertainty caused by manual intervention. This approach not only ensures timeliness and continuity of the compensation, but also considers production safety and traceability of compensation parameters, thereby improving machining accuracy and operational reliability of the BA double-swivel-head five-axis machine tool under complex postures.

In some embodiments, the processor obtains the target compensation value by adding the parameter compensation value of the BA double-swivel-head five-axis machine tool and the vector difference information.

The parameter compensation value refers to an inherent compensation value (e.g., COMP_VALUE or Xn1, Yn1, Zn1) stored in a built-in program or firmware of the numerical control system of the BA double-swivel-head five-axis machine tool for a specific swing angle posture, and serves as a base value for the compensation. In some embodiments, the processor obtains the parameter compensation value by invoking system-stored data.

For more descriptions of the vector difference information and the target compensation value, refer to the related content above.

In some embodiments, the processor reads an inherent parameter compensation value of the BA double-swivel-head five-axis machine tool at a current actual swing position (e.g., swing angle n), and algebraically adds the inherent parameter compensation value and the vector difference information (ΔXn, ΔYn, ΔZn) obtained above. The calculation is performed independently in each coordinate axis direction to obtain three components of the target compensation value (COMP_VALUE [n,0], COMP_VALUE [n,1], and COMP_VALUE [n,2]). For a specific calculation process related to the target compensation value, refer to the related content below.

In one or more embodiments of the present disclosure, the target compensation value is generated by adding the parameter compensation value of the BA double-swivel-head five-axis machine tool and the measured vector difference information item by item. This approach can implement efficient online or offline compensation update while ensuring stability and safety, thereby improving machining accuracy and production continuity of the BA double-swivel-head five-axis machine tool under complex postures.

With reference to FIG. 4 to FIG. 6, the present disclosure is further described in an implementation manner.

The probe fixing base 3 is installed on the worktable 4, the probe 2 is installed on the probe fixing base 3, the calibration bar is installed in the tool magazine, a compiled measurement program is executed to drive the probe 2 to measure the spherical head 1, a swing angle is moved to A30/B0, the probe 2 is moved to approach the spherical head 1 along positive and negative directions of X and Y axes respectively to measure multi-layer roundness coordinates on the sphere, coordinates of a first circle cross-section are [(X1, X2), (Y1, Y2)], coordinates of a second circle cross-section are [(X3, X4), (Y3, Y4)], and so on, coordinates of an nth circle cross-section are [(Xn, Xn+1), (Yn, Yn+1)], coordinates of each circle cross-section are averaged, for example, the X-axis coordinate of the first circle cross-section is an average value Xa1 of X1 and X2, the Y-axis coordinate of the first circle cross-section is an average value Ya1 of Y1 and Y2, that is, the center coordinates of first circle cross-section is (Xa1, Ya1), and so on, the center coordinate of the nth circle cross-section is (Xan, Yan), coordinate values of all circle cross-sections are averaged again to obtain actual TCP coordinates, that is, an actual TCP X-axis coordinate CENT1_X1=(Xa1+Xa2+ . . . +Xan)/n, and an actual TCP Y-axis coordinate CENT1_Y1=(Ya1+Ya2+ . . . +Yan)/n. According to the same principle, the swing angle is moved to A-30/B0, and actual TCP coordinates CENT1_X2 and CENT1_Y2 at this position are determined.

Then, the swing angle A is moved from +30° to −30°, when an equilateral triangle is used to calculate and obtain the swing angle A, a distance from a first rotation center to a spindle end face is determined as: λ1=|CENT_Y1-CENT_Y2|-L, where L is a length of the calibration bar. When an equilateral triangle is used to calculate and obtain the swing angle B, a distance from a second rotation center to the spindle end face is determined as: λ2=|CENT_X3-CENT_X4|-L. Then, an average of λ1 and λ2 is obtained as the distance from the rotation center to the spindle end face: λ=(λ1+λ2)/2.

The swing angle is moved to A0/B0, an X-axis coordinate and a Y-axis coordinate in reference TCP 3D coordinates, that is, BALL_X and BALL_Y, are measured and obtained according to the same manner described above, a linear axis of the BA double-swivel-head five-axis machine tool is moved to cause the probe 2 to move to a position where the X-axis coordinate and the Y-axis coordinate are BALL_X and BALL_Y, a top Z-axis coordinate BALL_Z0 of the spherical head is measured, and then a reference TCP Z-axis coordinate BALL_Z is determined according to a known spherical head radius R1, a known probe radius R2, and the distance λ from the rotation center to the spindle end face obtained above (BALL_Z=BALL_Z0-R1-R2-2). That is, the reference TCP 3D coordinates are BALL_X, BALL_Y, and BALL_Z.

According to swing angles set in a matrix list, TCP coordinates (BALL_Xn, BALL_Yn, and BALL_Zn) at the single-swing angle of A or B axis and composite angle are measured in sequence. A change amount of the coordinates at each swing angle is obtained by subtracting the reference TCP 3D coordinates at A0/B0 from the measured TCP coordinates. The change amount is a vector difference in space during movement of the BA double-swivel-head five-axis machine tool, specifically: ΔX1=BALL_X1-BALL_X, ΔY1=BALL_Y1-BALL_Y, ΔZ1=BALL_Z1-BALL_Z . . . , ΔXn=BALL_Xn-BALL_X, ΔYn=BALL_Yn-BALL_Y, ΔZn=BALL_Zn-BALL_Z.

The parameter compensation value of the BA double-swivel-head five-axis machine tool is read as follows:

X11=COMP_VALUE [1,0], Y11=COMP_VALUE [1,1], Z11=COMP_VALUE [1,2]. X11, Y11, and Z11 refer to compensation values in three directions when the BA double-swivel-head five-axis machine tool is at an angle corresponding to 1, respectively. Then, compensation values corresponding to the BA double-swivel-head five-axis machine tool at an angle corresponding to n may be represented as: Xn1=COMP_VALUE [n,0], Yn1=COMP_VALUE [n,1], Zn1=COMP_VALUE [n,2]. The read compensation values and the measured vector differences are used to obtain a new compensation value, i.e., the target compensation value, as follows:

$$COMP\_VALUE [ 1 , 0 ] = X 11 + △ X 1 ;$$

$$COMP\_VALUE [ 1 , 1 ] = Y 11 + △ Y 1 ;$$

$$COMP\_VALUE [ 1 , 2 ] = Z 11 + △ Z 1 , … …$$

$$COMP\_VALUE [ n , 0 ] = Xn 1 + △ Xn ;$$

$$COMP\_VALUE [ n , 1 ] = Yn 1 + △ Yn ;$$

$$COMP\_VALUE [ n , 2 ] = Zn 1 + △ Zn .$$

The accuracy compensation table is generated based on calculation results, and an accuracy error threshold XM is preset. When ΔXn, ΔYn, ΔZn≤XM, the program automatically invokes the accuracy compensation table and performs the accuracy compensation. When ΔXn, ΔYn, ΔZn>XM, a corresponding alarm is output, prompting that professional maintenance personnel are required for handling.

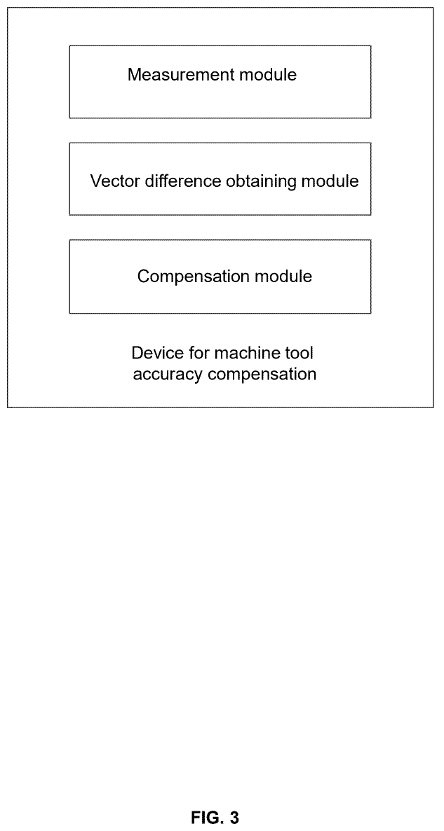

With reference to a functional block diagram of the device for machine tool accuracy compensation shown in FIG. 3, based on the same inventive concept as the foregoing embodiments, an embodiment of the present disclosure further provides a device for machine tool accuracy compensation. The device includes a calibration bar and a probe. The calibration bar includes a spherical head. The probe is installed on a worktable of a BA double-swivel-head five-axis machine tool. The calibration bar is installed in a tool magazine. The device further includes:
a measurement module, configured to use the probe to obtain a reference TCP X-axis coordinate and a reference TCP Y-axis coordinate when the A and B swivel heads of the BA double-swivel-head five-axis machine tool are at an initial position; move a linear axis of the BA double-swivel-head five-axis machine tool to cause the probe to be located at a position having coordinates identical to the reference TCP X-axis coordinate and the reference TCP Y-axis coordinate to obtain a top Z-axis coordinate of the spherical head; obtain a reference TCP Z-axis coordinate according to a distance from a rotation center to a spindle end face and the top Z-axis coordinate of the spherical head; and obtain reference TCP 3D coordinates according to the reference TCP X-axis coordinate, the reference TCP Y-axis coordinate, and the reference TCP Z-axis coordinate;
a vector difference obtaining module, configured to obtain vector difference information in each coordinate axis direction according to the reference TCP 3Dcoordinates and the actual TCP 3D coordinates, respectively; and
a compensation module, configured to obtain a target compensation value according to a parameter compensation value of the BA double-swivel-head five-axis machine tool and the vector difference information; wherein the target compensation value is used for accuracy compensation of the BA double-swivel-head five-axis machine tool at the actual swing position.

For more related descriptions in a process for obtaining the target compensation value through the device for machine tool accuracy compensation, refer to the related content described above.

The method of the present disclosure uses the probe to replace manual detection, uses the TCP coordinates when the swivel heads are at the initial position as a reference, and uses the TCP coordinates when the swivel heads are at the actual swing position and the reference coordinates to obtain the vector difference information in each coordinate axis direction in space, that is, implements accuracy detection of the BA double-swivel-head five-axis machine tool, thereby accurately and efficiently obtaining an accuracy deviation of the BA double-swivel-head five-axis machine tool. Because the automated machine tool has a self-compensation function, the inherent parameter compensation value of the BA double-swivel-head five-axis machine tool is combined with the actually obtained accuracy deviation, thereby avoiding a large error caused by separately performing compensation using the inherent parameter compensation value, and comprehensively obtaining the target compensation value to implement more accurate compensation, effectively improving quality of the machine tool accuracy compensation.

A person skilled in the art should understand that division of the modules in the embodiment is merely division of logical functions. In actual application, the modules may be fully or partially integrated into one or more physical entities. The modules may be fully implemented in a form of software invoked by a processing unit, fully implemented in a form of hardware, or implemented in a form of a combination of software and hardware. It should be noted that, in this embodiment, the modules in the device for machine tool accuracy compensation are in one-to-one correspondence with the steps in the method for machine tool accuracy compensation in the foregoing embodiment. Therefore, for an implementation manner of this embodiment, refer to the implementation manner of the foregoing method for machine tool accuracy compensation. Details are not described herein again.

Based on the same inventive concept as the foregoing embodiments, an embodiment of the present disclosure further provides a non-transitory computer-readable storage medium, storing a computer program, wherein, the computer program, when loaded and executed by a processor, implements the method for machine tool accuracy compensation.

In addition, based on the same inventive concept as the foregoing embodiments, an embodiment of the present disclosure further provides an electronic device, including at least a processor and a memory.

The memory is configured to store a computer program.

The processor is configured to load and execute the computer program, to cause the electronic device to execute the method for machine tool accuracy compensation provided in the embodiment of the present disclosure.

In some embodiments, the non-transitory computer-readable storage medium may be a memory such as Ferroelectric Random Access Memory (FRAM), Read-Only Memory (ROM), Programmable Read-Only Memory (PROM), Erasable Programmable Read-Only Memory (EPROM), Electrically Erasable Programmable Read-Only Memory (EEPROM), flash memory, magnetic surface memory, optical disk, or CD-ROM, or may be various devices including one or any combination of the foregoing memories. A computer may be various computing devices including an intelligent terminal and a server.

In some embodiments, executable instructions may be in a form of a program, software, a software module, a script, or code, written in any form of programming language (including a compiled or interpreted language, or a declarative or procedural language), and may be deployed in any form, including being deployed as a stand-alone program or as a module, a component, a subroutine, or another unit suitable for use in a computing environment.

Merely by way of example, the executable instructions may, but do not necessarily, correspond to a file in a file system, may be stored as a part of a file storing another program or data, for example, stored in one or more scripts in a hypertext markup language (HTML) document, stored in a single file dedicated to the program in question, or stored in a plurality of collaborative files (for example, files storing one or more modules, subroutines, or portions of code).

Merely by way of example, the executable instructions may be deployed to be executed on one computing device, or executed on a plurality of computing devices located at one site, or executed on multiple computing devices distributed at multiple sites and interconnected through a communication network.

It should be noted that, in this document, the term “include”, “comprise”, or any other variant thereof is intended to cover a non-exclusive inclusion, so that a process, manner, article, or system that includes a series of elements not only includes those elements, but also includes other elements that are not expressly listed, or further includes elements inherent to such a process, manner, article, or system. In the absence of more limitations, an element defined by the statement “include a . . . ” does not exclude the existence of additional identical elements in the process, manner, item, or system that includes the element.

The order of the embodiments in the present disclosure is for description only and does not represent the quality of the embodiments.

Through the description of the above embodiments, those skilled in the art may clearly understand that the above embodiment manners may be implemented by means of software plus a necessary general hardware platform, and certainly may also be implemented through hardware, but in many cases the former is a better implementation. Based on such understanding, the technical solution of the present disclosure, which is essential or the part contributing to the prior art, may be embodied in the form of a software product. The computer software product is stored in a storage medium (such as a ROM/RAM, a magnetic disk, or an optical disk) and includes several instructions for enabling a multimedia terminal device (which may be a mobile phone, a computer, a television receiver, a network device, etc.) to execute the manners described in the various embodiments of the present disclosure.

In summary, the present disclosure provides a method and a device for machine tool accuracy compensation, a storage medium, and an electronic device. In the method, the probe replaces manual detection. TCP coordinates when swivel heads are at an initial position are used as a reference. TCP coordinates when the swivel heads are at an actual swing position and the reference coordinates are used to obtain vector difference information in each coordinate axis direction in space, that is, to implement accuracy detection of a BA double-swivel-head five-axis machine tool. An accuracy deviation of the BA double-swivel-head five-axis machine tool is obtained accurately and efficiently. Since an automated machine tool has a self-compensation function, an inherent parameter compensation value of the machine tool is combined with the actually obtained accuracy deviation to avoid an excessively large error caused by separate compensation using the inherent parameter compensation value. A target compensation value is comprehensively obtained to achieve more accurate compensation. All detection and compensation actions are programmed and stored in an internal controller of the BA double-swivel-head five-axis machine tool, and are automatically executed by means of program invocation to avoid manual intervention and reduce human error, resulting in higher and more stable accuracy detection efficiency, thereby effectively improving quality of machine tool accuracy compensation, and guaranteeing part machining quality.

The above descriptions are merely preferred embodiments of the present disclosure and are not intended to limit the present disclosure. Any modifications, equivalent replacements, improvements, etc., made within the spirit and principle of the present disclosure shall be included within the protection scope of the present disclosure.

What is claimed is:

1. A method for machine tool accuracy compensation, applied to a device for machine tool accuracy compensation, wherein the device includes a calibration bar and a probe, the calibration bar includes a spherical head, the probe is installed on a worktable of a BA double-swivel-head five-axis machine tool, the calibration bar is installed in a tool magazine, and the method comprises:
obtaining, using the probe, actual tool center point (TCP) 3D coordinates of the spherical head when A and B swivel heads of the BA double-swivel-head five-axis machine tool are at an actual swing position;
obtaining, using the probe, a reference TCP X-axis coordinate and a reference TCP Y-axis coordinate when the A and B swivel heads of the BA double-swivel-head five-axis machine tool are at an initial position;
moving a linear axis of the BA double-swivel-head five-axis machine tool to cause the probe to be located at a position having coordinates identical to the reference TCP X-axis coordinate and the reference TCP Y-axis coordinate to obtain a top Z-axis coordinate of the spherical head;
obtaining a reference TCP Z-axis coordinate according to a distance from a rotation center to a spindle end face and the top Z-axis coordinate of the spherical head;
obtaining reference TCP 3D coordinates according to the reference TCP X-axis coordinate, the reference TCP Y-axis coordinate, and the reference TCP Z-axis coordinate;
obtaining vector difference information in each coordinate axis direction according to the reference TCP 3D coordinates and the actual TCP 3D coordinates, respectively; and
obtaining a target compensation value according to a parameter compensation value of the BA double-swivel-head five-axis machine tool and the vector difference information; wherein the target compensation value is used for accuracy compensation of the BA double-swivel-head five-axis machine tool at the actual swing position.

2. The method of claim 1, wherein before obtaining the reference TCP Z-axis coordinate according to the distance from the rotation center to the spindle end face and the top Z-axis coordinate of the spherical head, the method further comprises:
within swinging ranges of the A and B swivel heads of the BA double-swivel-head five-axis machine tool, obtaining first TCP coordinates and second TCP coordinates of the spherical head at symmetrical swing positions about the initial position of the A and B swivel heads; and
obtaining the distance from the rotation center to the spindle end face according to a length of the calibration bar, single-swing angles of the A and B swivel heads, the first TCP coordinates, and the second TCP coordinates.

3. The method of claim 2, wherein the obtaining the distance from the rotation center to the spindle end face according to a length of the calibration bar, single-swing angles of the A and B swivel heads, the first TCP coordinates, and the second TCP coordinates includes:
respectively calculating, according to the length of the calibration bar, the single-swing angles of the A and B swivel heads, the first TCP coordinates, and the second TCP coordinates, a distance from the rotation center to the spindle end face within the swinging ranges of the A and B swivel heads, to obtain a distance from a first rotation center to the spindle end face and a distance from a second rotation center to the spindle end face; and
obtaining, according to an average value of the distance from the first rotation center to the spindle end face and the distance from the second rotation center to the spindle end face, the distance from the rotation center to the spindle end face.

4. The method of claim 1, wherein, the obtaining, using the probe, actual TCP 3D coordinates of the spherical head when A and B swivel heads of the BA double-swivel-head five-axis machine tool are at an actual swing position, includes:
obtaining, using the probe and employing multi-layer roundness coordinate calculation, the actual TCP 3D coordinates of the spherical head when the A and B swivel heads of the BA double-swivel-head five-axis machine tool are at the actual swing position.

5. The method of claim 4, wherein, the obtaining, using the probe and employing multi-layer roundness coordinate calculation, the actual TCP 3D coordinates of the spherical head when the A and B swivel heads of the BA double-swivel-head five-axis machine tool are at the actual swing position, includes:
obtaining, using the probe, multi-layer roundness coordinates on the spherical head when the A and B swivel heads of the BA double-swivel-head five-axis machine tool are at the actual swing position;
obtaining, according to an average value of roundness coordinates of each layer among the multi-layer roundness coordinates on the spherical head, a plurality of single-layer roundness coordinates; and
obtaining, according to an average value of the plurality of single-layer roundness coordinates, the actual TCP 3D coordinates of the spherical head.

6. The method of claim 1, wherein after obtaining the vector difference information in each coordinate axis direction according to the reference TCP 3D coordinates and the actual TCP 3D coordinates, respectively, the method further comprises:
determining whether the vector difference information in each coordinate axis direction is greater than a preset accuracy error threshold, and executing machine-tool alarm handling when the vector difference information in each coordinate axis direction is greater than the preset accuracy error threshold.

7. The method of claim 1, wherein after obtaining the vector difference information in each coordinate axis direction according to the reference TCP 3D coordinates and the actual TCP 3D coordinates, respectively, the method further comprises:
determining whether the vector difference information in each coordinate axis direction is greater than a preset accuracy error threshold, and automatically invoking an accuracy compensation table to execute accuracy compensation when the vector difference information in each coordinate axis direction is not greater than the preset accuracy error threshold.

8. The method of claim 1, wherein, the obtaining a target compensation value according to a parameter compensation value of the BA double-swivel-head five-axis machine tool and the vector difference information, includes:
obtaining, by adding the parameter compensation value of the BA double-swivel-head five-axis machine tool and the vector difference information, the target compensation value.

9. A device for machine tool accuracy compensation applying the method for machine tool accuracy compensation of claim 1, wherein, the device includes the calibration bar and the probe, the calibration bar includes the spherical head, the probe is installed on the worktable of the BA double-swivel-head five-axis machine tool, the calibration bar is installed in the tool magazine, and the device further comprises:
a measurement module, configured to use the probe to obtain the actual TCP 3D coordinates of the spherical head when the A and B swivel heads of the BA double-swivel-head five-axis machine tool are at the actual swing position;
the measurement module is configured to use the probe to obtain the reference TCP X-axis coordinate and the reference TCP Y-axis coordinate when the A and B swivel heads of the BA double-swivel-head five-axis machine tool are at the initial position; move the linear axis of the BA double-swivel-head five-axis machine tool to cause the probe to be located at the position having coordinates identical to the reference TCP X-axis coordinate and the reference TCP Y-axis coordinate to obtain the top Z-axis coordinate of the spherical head; obtain the reference TCP Z-axis coordinate according to the distance from the rotation center to the spindle end face and the top Z-axis coordinate of the spherical head; and obtain the reference TCP 3D coordinates according to the reference TCP X-axis coordinate, the reference TCP Y-axis coordinate, and the reference TCP Z-axis coordinate;
a vector difference obtaining module, configured to obtain the vector difference information in each coordinate axis direction according to the reference TCP 3D coordinates and the actual TCP 3D coordinates, respectively; and
a compensation module, configured to obtain the target compensation value according to the parameter compensation value of the BA double-swivel-head five-axis machine tool and the vector difference information; wherein the target compensation value is used for accuracy compensation of the BA double-swivel-head five-axis machine tool at the actual swing position.

10. A non-transitory computer-readable storage medium, storing a computer program, wherein, the computer program, when loaded and executed by a processor, implements the method for machine tool accuracy compensation of claim 1.

11. An electronic device, comprising a processor and a memory, wherein:
the memory is configured to store a computer program;
the processor is configured to load and execute the computer program, to cause the electronic device to execute the method for machine tool accuracy compensation according to claim 1.
